(19) United States
(12) Patent Application Publication
(10) Pub. No.: US 2025/0211951 A1
(43) Pub. Date: Jun. 26, 2025

(54) SYSTEM AND METHOD FOR EXPEDITED BORDER CROSSING

(71) Applicant: MOTOROLA SOLUTIONS, INC., CHICAGO, IL (US)

(72) Inventors: JOSEPH NAMM, PLANTATION, FL (US); ANDREW J JANECEK, CORAL SPRINGS, FL (US); BARBARA R DOUTRE, PLANTATION, FL (US); SUBHASH P NAIR, DAVIE, FL (US); JAKE RENKO, CORAL SPRINGS, FL (US); RAIMA MATHEW, DAVIE, FL (US); ARMAGHAN MEHRSA, BOYNTON BEACH, FL (US)

(21) Appl. No.: 18/392,589

(22) Filed: Dec. 21, 2023

(51) Int. Cl. H04W 4/35; H04W 4/021; H04W 76/10

(52) U.S. Cl. CPC H04W 4/35; H04W 4/021; H04W 76/10

(57) ABSTRACT

Techniques for managing a border crossing are provided including automatically establishing a vehicle-to-border communication link with a border checkpoint server in response to the vehicle crossing into a geo-fenced area associated with a customs and border protection (CBP) checkpoint. The CBP server is granted temporary control of internal and external vehicular devices such as cameras, sensors, and communication devices associated with the vehicle to provide vehicle, occupant and cargo identification information. The vehicle, occupant, and cargo identification information is relayed to the CBP server and validated based on occupant responses to automated virtual assistant (VA) CBP interview queries, generated by the CBP server. The vehicle is automatically receiving granted access to a fast pass lane of the CBP checkpoint in response to the vehicle, occupant and cargo identification being validated by the CBP server.

### BACKGROUND

Thousands of individuals, vehicles, and goods cross over the border between countries each day. Delays in processing people, vehicles, and/or goods at the border may result in traffic congestion. Traffic congestion at a border crossing may result in travel delays as well as disruption in delivery of goods and services to endpoint destinations.

Accordingly, there is a need to expedite approaches to border crossing.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is an example illustration of an expedited border crossing in accordance with some embodiments.

FIG. 2 is a block diagram of architectural elements for implementing the expedited border crossing of FIG. 1 in accordance with some embodiments.

FIG. 3 is a flowchart of a method for expedited border crossing in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

Briefly, there is provided herein techniques for managing a border crossing are provided including automatically establishing a vehicle-to-border communication link with a border checkpoint server in response to the vehicle crossing into a geo-fenced area associated with a customs and border protection (CBP) checkpoint. The CBP server is granted temporary control of internal and external vehicular devices such as cameras, sensors, and communication devices associated with the vehicle to provide vehicle, occupant and cargo identification information. The vehicle, occupant, and cargo identification information is relayed to the CBP server and validated based on occupant responses to automated virtual assistant (VA) CBP interview queries, generated by the CBP server. The vehicle is automatically receiving granted access to a fast pass lane of the CBP checkpoint in response to the vehicle, occupant and cargo identification being validated by the CBP server.

Further advantages and features consistent with this disclosure will be set forth in the following detailed description, with reference to the figures.

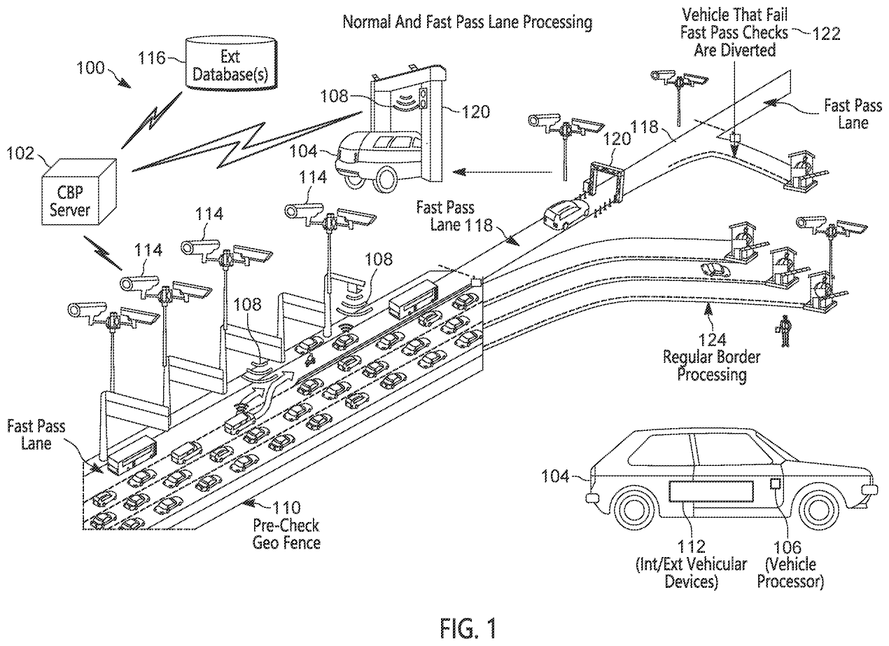

FIG. 1 is an example illustration of a communication system for border crossing pre-check 100 operating in accordance with some of the embodiments described herein. The border crossing pre-check 100 includes a customs and border patrol (CBP) server 102 for processing a plurality of vehicles, wherein at least one vehicle, shown a vehicle 104, comprises an in-vehicle processor 106.

In accordance with some embodiments, the in-vehicle processor 106 is configured to automatically establish a vehicle-to-border wireless communication link 108 with the CBP server 102 in response to the vehicle 104 crossing into a pre-check, geo-fenced area 110 associated with the CBP pre-check. The geo-fenced area 110 is preferably established as an area in which vehicles are traveling/moving, prior to any fixed or stationary checkpoints, such as manual in-person checkpoints 122 and 124. Vehicles that do not have or that do not use the system are processed through regular in-person border processing lanes 124.

In accordance with some embodiments, the in-vehicle processor 106 is further configured to grant the CBP server 102 temporary control of predetermined vehicular devices 112 that can be used for identification of the vehicle, vehicle occupants, and cargo. Examples of such internal and external vehicular devices 112 may include but are not limited to, vehicular cameras (internal and external), sensors, infotainment system that can be used to provide vehicle, occupant, and cargo information.

The CBP server 102 is configured with CBP processor, memory, and analytics engine (shown in later views). In accordance with the embodiments, the CBP server 102 is further configured with a virtual assistant (VA) for generating automated interview queries pertaining to the vehicle, vehicle occupants and cargo. In accordance with the embodiments, the in-vehicle processor 106 is also further configured to receive automated VA CBP interview queries, generated by the CBP server 102, for each identified occupant. The VA CBP interview queries may be played out at one of the in-vehicle devices under the control of CBP server 102, for example at the in-vehicle infotainment system, occupant cell phone, or tablet. Occupant responses to the VA queries may be entered (e.g. audio, text and/or scan input) into the corresponding in-vehicle device.

The server's virtual assistant may be accessed automatically upon entering the geo-fence 110 or by entering a prompt to a communications device within the vehicle having a human machine interface, such as cell phone, tablet, infotainment system or the like. The prompt is received by the in-vehicle processor 106, which then communicates the prompt to the server's VA.

Occupant responses to the VA queries are analyzed by the CBP server 102 to provide validation of the identified vehicle, occupant and cargo. For example, the CBP server 102 may perform analytics within the geo-fenced area 110 to cross-correlate occupant responses to the VA queries with the collected images and scans associated with the vehicle, occupants, and cargo of the vehicle. Thus, validation may advantageously take place while the vehicle is moving within the geo-fenced area 110.

In accordance with some embodiments, the in-vehicle processor 106 is automatically granted access, by the CBP server 102, to a fast pass lane 118 (with no further CBP checkpoint) in response to the occupant and cargo identification being validated by the CBP server 102.

In response to validation, the vehicle 104 receives a notification, from the CBP server 102, to proceed along the fast pass lane 118. The notification may be communicated by the CBP server 102, over wireless link 108, for playout (audio or display) at one of the in-vehicle devices, for example at the in-vehicle device which played out the VA queries, for example the infotainment system, occupant cell phone, or tablet.

In some embodiments, the fast pass lane 118 may further include a CBP electronic follow-up pre-check 120, also under the control of CBP server 102, which provides a light and/or electronic signage directing the vehicle to do one of: continue to proceed along the fast pass lane 118, stop for further electronic validation, or divert vehicle to in-person border processing lane 122. Vehicles that fail validation may be diverted (for example via electronic signage or arrow light) to the manual checkpoint location 122. As mentioned earlier, vehicles that do not have or that do not use the system are processed through regular in-person border processing lanes 124.

The CBP electronic follow-up checkpoint 120 may also be used to perform follow-up verifications with the vehicle stopped. While initial validation is performed while the vehicle is moving, there may be conditions (e.g. weather preventing clear images) where the validation is unable to be completed. Improved images and/or scans and/or additional VA queries may be performed at the CBP electronic follow-up checkpoint 120, communicated to the CBP server 102, where analytics are performed thereon and compared to responses to VA interview queries. In response to an improper validation, the vehicle receives a notification from the CBP server 102 to divert to a manual in-person checkpoint 122 as previously described. The electronic follow-up pre-check 120 thus provides backup for the system by validating the vehicle while the vehicle is stopped.

In some embodiments, a user may pre-register (for example via computer, cell phone, or in vehicle computer) a user and vehicle via a fast pass CBP application. The registration may also include automated granting of access permissions for the CBP server to validate a vehicle, occupants of the vehicle and content of the vehicle. Such pre-registration allows for automatically establishing the vehicle-to-border communication link, such as wireless link 108, within a predetermined geo-fence, such as geo-fence 110, for pre-check of registered users and vehicles. Such pre-registration may further include permission for the link to automatically connect vehicular communication devices and personal communication devices within the vehicle to a CBP server 102. Such registration may include, for example, uploading photo ID, passport, voiceprint, and/or other personal identification and/or biometrics, for example, uploading fingerprint, voiceprint, eye scan and/or other biometric information. Cross-correlation of registered identifier elements may be performed to facilitate and expedite verification upon arrival to a CBP checkpoint. For example, a photo ID may be cross-correlated to a voice biometric identifier to facilitate matching an in-vehicle image of driver or occupant to verbal responses to VA interview queries. Cross-correlation of cell phone location history (obtained based on the granted access) may be compared to responses to the VA CBP interview queries pertaining to farm/livestock.

In some embodiments, the temporary control granted to the CBP server 102 may include collecting (for example from in-vehicle camera, on-vehicle camera, and/or/remote scanners and/or internal scanners) images, video, and or scans of the vehicle occupants and cargo while passing through the geo-fenced area 110. For example, the geo-fenced area 110 may also include CBP cameras and/or remote scanners 114 mounted to traffic poles for gathering/collecting additional images of the vehicle 104 and occupants while traveling within the geo-fenced area 110. In some embodiments, the temporary control granted to the CBP server 102 may include collecting biometric information of vehicle occupants, for example eye scan, fingerprint scan, and/or voiceprint to name a few, while passing through the geo-fenced area 110. In some examples, the temporary control granted to the CBP server 102 may further include scanning using laser spectroscopy to detect traces of illicit substances as part of the automated system.

In some embodiments, the VA CBP queries may be generated for in-vehicle play out at communication device(s) within the vehicle, such as a car infotainment system, cell phone, or the like. The VA CBP queries may be played out, and responded to, while the vehicle passes through a geo-fenced area, such as geo-fenced area 110.

In some embodiments, where pre-registration has taken place, the virtual assistant in-vehicle CBP interview queries may be customized for each registered user. The server 102 analyzes the voiceprint of occupant responses to the VA CBP queries and validates that the responding occupant is a registered user. For example, the server 102 may be configured to compare responses to the VA CBP queries to data derived from the images/scans of vehicle cargo and the data derived from the biometric information and sensor data, and identification of the occupant. The server 102 can then verify occupant and vehicle based on matched occupant image match, voiceprint match, content match, and/or biometric match to name a few. For example, a voiceprint or audio profile generated from the query responses may be associated with images of a passenger of the vehicle as part of the validation.

For some embodiments in which the vehicle 104 is an autonomous (self-driving) vehicle, the validated autonomous vehicle, including verified occupants and cargo, may be automatically driven to the fast pass lane 118.

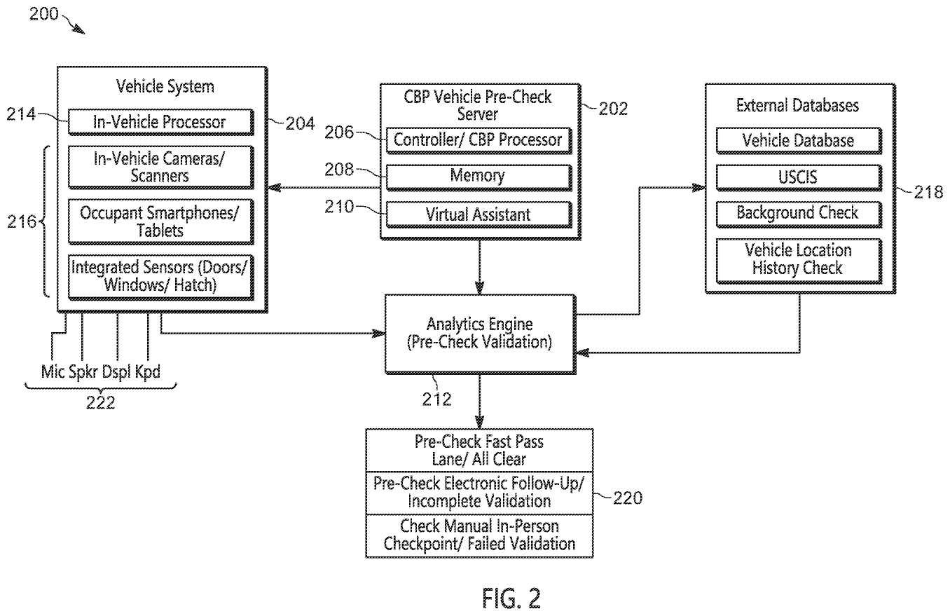

The CBP server 102 having its own CBP processor, memory, and analytics engine. The memory (shown in FIG. 2) includes instructions for controlling predetermined devices of the vehicle that can be used to acquire information to identify the vehicle, occupant(s), and/or cargo. The analytics engine performs analytics on the acquired information to detect inconsistencies between responses to the VA CBP interview queries and the images, video and/or scans of the vehicle, occupants, and/or cargo. The CBP server 102 may further generate additional VA CBP interview queries based on the inconsistencies. For example, a response to a tobacco and/or alcohol query, which does not align with images of such products in the vehicle, may results in automated duty/tax being calculated and charged, by the CP server, based on cargo content exceeding permitted limits.

The CBP server may be further communicatively coupled with one or more external database(s) 116, such as vehicular registration databases, immigration databases, criminal background check databases, pharmacy location databases, and vehicular location databases. The VA CBP interview queries may be based on information retrieved from the external database 116. Retrieved information from such external database 116 (e.g. license plate, image of vehicle owner, passenger information) being matched to the current images and responses to VA CBP interview queries facilitate the validation. Analytics performed by the CBP server 102 may further include comparing responses to VA CBP queries and/or information collected from images, video, and/or scans to information retrieved from the external database 116. For example, the VA CBP interview queries may be automatically customized based on past location tracking of a vehicle (e.g. location known for drugs, location known for crime, etc.). For example, some countries (or even state to state) allow certain drugs to be purchased without a prescription, while others require a prescription. If the vehicle location history or cell phone history indicates proximity to establishments which cell drugs considered illegal at the entering country then VA CBP interview queries may e generated on this basis.

Responses to queries may be scored based on how well the response aligns with the identified vehicle, occupant(s), and/or cargo. Weighting factors may be applied to predetermined identification pre-check parameters associated with the VA CBP interview queries to indicate when manual inspection is recommended. For example, a higher weighting factor may be applied to abnormal cell phone location history, unusual cell phone contact history, and/or mismatch between response to queries and scan of cell phone content. For example, a higher weighting factor may be applied to responses to VA queries pertaining to proximity to livestock and a determination that a cell phone within the vehicle has been near a farm location.

In some embodiments, the in-vehicle processor 106 is further configured to automatically detect changes in: vehicle door position, vehicle window position, vehicle seat position, and vehicle trunk position, wherein a change in position is communicated to the CBP server 102. Such changes may be indicative of an inconsistency (e.g. attempt to hide an object of interest, throw out an object of interest, move occupant or cargo from trunk through back seat that pushes down, switch occupants in and/or out of the vehicle, etc Detecting inconsistencies like door opening, window opening, movement from passenger compartment to trunk vice/versa etc, after granting fast pass may trigger a revocation of the fast-pass, and direct vehicle to normal/manual check The detected inconsistency may also be communicated from the CBP server 102 to the manual border crossing(s).

In some embodiments, an initial crossing (or potential crossing) of the vehicle into the geo-fenced area 110 may trigger an initial check by the CBP server 102 as to occupant/vehicle intent. For example, a user entering a destination into a map application that would take the vehicle across an international border, or commit the vehicle to a road that ultimately leads to a border crossing may trigger an inquiry and check by the CBP server 102 as to the occupant/vehicle intent,

In some embodiments, a history of border crossing information, queries, and responses may be archived and used by the CBP server 102 to facilitate inspection of failed validations that were diverted to manual inspection checkpoints 122, 124 and/or used for subsequent crossings by the same vehicle and/or occupant at another time.

FIG. 2 is a block diagram of example architectural elements 200 for implementing the expedited border crossing of FIG. 1 in accordance with some embodiments. The architectural elements 200 include a CBP pre-check server 202 and a vehicle system 204. The CBP pre-check server 202 comprises a controller with processor 206, a memory 208, a virtual assistant 210, and an analytics engine 212. The analytics engine 212 may be integrated as part of the pre-check server 202 or may be cloud based and in communication with the CBP pre-check server.

The vehicle system 204 includes an in-vehicle processor 214 and predetermined vehicular devices 216. The predetermined devices 216 may include internal and external vehicular cameras, sensors, and communication devices associated with the vehicle, which are capable of providing information pertaining to the vehicle, the vehicle occupants, and/or cargo within the vehicle. Memory 208, of pre-check server 202, includes a set of instructions stored therein for temporarily controlling the predetermined vehicle devices 216 of vehicle system 204. For example, the vehicle devices 216 may include in-vehicle cameras, occupant smart phones, tablets, and/or integrated sensors to name a few.

The in-vehicle processor 214 is configured to automatically establish a vehicle-to-border communication link with the CBP server 202, in response to the vehicle crossing into a geo-fenced area associated with a CBP pre-checkpoint as previously described. Upon establishment of the communication link, the in-vehicle processor 214 grants temporary control of the predetermined vehicular devices 216 to the CBP pre-check server 202. The server 202 uses the instructions stored in memory 208 to control the predetermined vehicular devices 216. The predetermined vehicular devices 216 may include for example, internal and external vehicular cameras, sensors, and communication devices associated with the vehicle to determine occupant and cargo identification. For example, images and scanned information may be uploaded to the CBP server.

Information gathered from the predetermined vehicular devices 216 is then used by the server's virtual assistant 210 as a basis to generate automated virtual assistant (VA) CBP interview queries pertaining to the identified occupants, cargo, and vehicle. The queries may be generated for each identified occupant of the vehicle. A plurality of interface devices 222, such as microphone, speaker, display with pull down menu and/or keypad, may be used to communicate responses to the VA CBP queries. Responses to the queries input by the occupants are provided to the analytics engine 212 and compared to the information retrieved from the predetermined vehicular devices 216 to determine a validation status for the vehicle (correct responses support validation). One or more audio profiles may be determined, by the analytics engine 212, in response to the verbal responses to the VA CBP interview queries. The one or more audio profiles may be associated with images of passengers within the vehicle to further support validation. The VA CBP queries may include requests for additional scan input from the occupant(s), such as fingerprint, palm, and/or eye scans.

The analytics engine 212 may be programmed to apply a score to the responses to queries based on how well the response(s) align with the identified vehicle, occupant(s), and/or cargo as retrieved by the predetermined vehicular devices 216. For example, ten queries with ten correct responses may result in an all clear validation. A score of eight out of ten or nine out of ten may result in an insufficient validation score. Responses of seven out of ten or less may be considered a failed score.

Weighting factors may be applied to predetermined identification pre-check parameters associated with the VA CBP interview queries. For example, a higher weighting factor may be applied to a mismatch between response to query pertaining to cell phone location and retrieved information as to cell phone location. For example, retrieved cell phone history indicates that a cell phone within the vehicle has been used in a location known for drug crime and response to query as to cell phone location does not align. As another example, a higher weighting factor may be applied to responses to VA queries pertaining to proximity to livestock and a determination that a cell phone within the vehicle has been near a farm location. These weighting factors can be applied to adjust the scoring.

The CBP pre-check server 202 and analytics engine 212 may be further communicatively coupled to one or more external databases 218 such as: vehicular registration databases, immigration databases (USCIS), criminal background check databases, and vehicular location databases. The analytics performed by analytics engine 212 may further include cross-correlating information retrieved by the predetermined vehicular devices 216 and the occupant responses (VA queries) to the various external databases 218.

In accordance with some embodiments, the CBP pre-check server 202 generates instructions 220 to communicate to the vehicle system 204 indicating directions for the vehicle to take in response to the validation status. For example, the instructions may direct the vehicle to remain on the fast pass lane, with no further CBP check, in response to an all-clear validation. An insufficient or incomplete validation may result in instructions that direct the vehicle to stop and the electronic follow-up pre-checkpoint 120 of FIG. 1 subsequent electronic verification. A failed validation results in instructions may direct the vehicle to a manual lane managed by in-person CBP personnel.

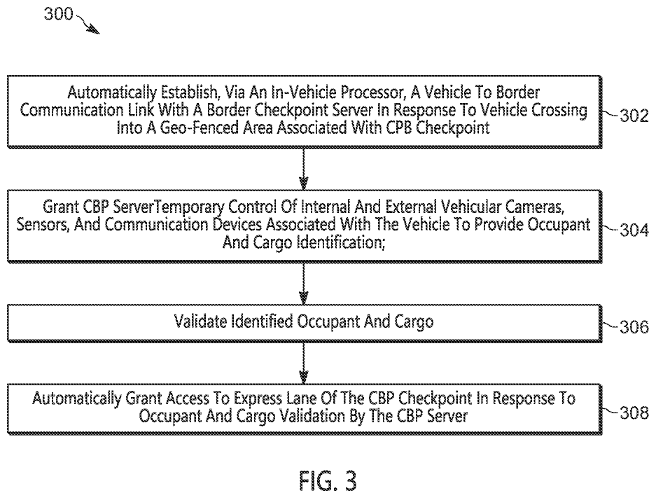

FIG. 3 is a flowchart of a method 300 for managing a border crossing in accordance with some embodiments. The method includes, at 302, automatically establishing a vehicle-to-border communication link with a CBP server in response to a vehicle crossing into a geo-fenced area associated with the server. For example, vehicle 104 of FIG. 1 automatically established a vehicle-to-border wireless communication link 108 with the CBP server 102, in response to a vehicle crossing into a geo-fenced area 110.

The method further includes, at 304, granting the CBP server temporary control of predetermined vehicular devices, such as internal and external vehicular cameras, sensors, and communication devices associated with the vehicle, to determine occupant and cargo identification. For example, the CBP server 102 of FIG. 1 was granted access to internal/external vehicular devices 112.

The method includes, at 306, validating the identified occupant and cargo based on occupant responses to automated VA CBP interview queries, generated by the CBP server, for each identified occupant. The method also includes, at 308, automatically receiving granted access to a fast pass lane in response to the occupant and cargo identification being validated by the CBP server. For example, at FIG. 1, validation of identified occupant and cargo based on occupant responses to automated VA CBP interview queries resulted in granted access to fast pass lane 118.

In some embodiments, prior to automatically establishing the vehicle-to-border communication link at 302, registering (for example via computer, cell phone, or in vehicle computer) a user and vehicle to a fast pass CBP application. Such registration may include, for example, uploading photo ID, passport, voiceprint, and/or other biometrics. The registration may also include automated granting of access permissions for the CBP server to validate a vehicle, occupants of the vehicle and content of the vehicle. Such pre-registration allows for automatically establishing a vehicle-to-border communication link within a predetermined geo-fence of a border checkpoint for registered users and vehicles. Such pre-registration may further include permission for the link to automatically connect vehicular communication devices and personal communication devices within the vehicle to a CBP server.

In some embodiments, granting the CBP server temporary control at 304 may further include collecting images, video and/or scans of the vehicle and vehicle occupants and cargo while passing through the geo-fenced area. For example, the CBP server 102 of FIG. 1 may control vehicular devices 112, such as an in-vehicle camera, on-vehicle camera, and/or scanners. The CBP server may retrieve images, video as well as biometric information retrieved from scanners (fingerprint, eye scan, voiceprint) of vehicle occupants and/or content while passing through the geo-fenced area 110 of FIG. 1.

In some embodiments, the VA CBP interview queries used for validation of identified occupant and cargo at 306 may be generated for in-vehicle play out at a communication device within the vehicle, while passing through the geo-fenced area. For example, the CBP interview queries may play out as audio or be displayed on vehicle infotainment system, car radio, cell phone, or tablet or the like. In some embodiments, the VA in-vehicle CBP interview queries may be customized for each registered user of the vehicle, for example based on responses to initial queries and/or based on information gathered from pre-registration.

In some embodiments, the validation at 306 may further include analyzing voiceprint of occupant responses to the VA CBP queries and validate that the responding occupant is a registered user, comparing responses to the VA CBP queries to data derived from the images/scans of vehicle cargo and the data derived from the biometric information and sensor data, and identification of the occupant, and verifying occupant and vehicle based on matched occupant image match, voiceprint match, content match, biometric match.

For embodiments in which the vehicle is an autonomous (self-driving) vehicle, the automatically receiving granted access at 308 may further include automatically controlling a verified autonomous vehicle including verified occupants and verified vehicle cargo to a fast pass lane, such as lane 118 of FIG. 1, for border crossing.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with a CBP server, nor grant temporary control of internal/external vehicular cameras, sensors, and communication devices associated with a vehicle to determine occupant and cargo identification as well verification of human responses to computer generated queries pertaining to the occupants, vehicle, and cargo).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential feature or element of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A communication system to managing a border crossing, comprising:
a customs and border patrol (CBP) server for processing a plurality of vehicles, wherein at least one vehicle comprises:
an in-vehicle processor configured to:
automatically establish a vehicle-to-border communication link with the CBP server in response to the vehicle crossing into a geo-fenced area associated with a CBP checkpoint;
grant the CBP server temporary control of internal and external predetermined vehicular devices associated with the vehicle to determine occupant and cargo identification information;
receive automated virtual assistant (VA) CBP interview queries, generated by the CBP server, for each identified occupant, wherein occupant responses to the queries are analyzed by the CBP server to provide validation of the occupant and cargo identification information; and
automatically receive granted access to a fast pass lane in response to the occupant and cargo identification information being validated by the CBP server.

2. The communication system of claim 1 wherein, prior to automatically establishing the vehicle-to-border communication link, the in-vehicle processor is configured to:
register a user and vehicle to a fast pass CBP application, the registration including granting of access permissions for validating a vehicle, occupants of the vehicle and content of the vehicle; and
automatically establish the vehicle-to-border communication link within a predetermined geo-fence of a border crossing for registered users and vehicles, the vehicle-to-border communication link automatically connecting vehicular communication devices and personal communication devices within the vehicle to the CBP server.

3. The communication system of claim 1, wherein the CBP server performs analytics to detect inconsistencies between responses to the VA CBP interview queries and the occupant and cargo identification information determined by the internal and external predetermined vehicular devices, and the CBP server further generates additional VA CBP interview queries based on the inconsistencies.

4. The communication system of claim 3, wherein the analytics include applying scoring and weighting factors are applied to predetermined identification pre-check parameters associated with the VA CBP interview queries.

5. The communication system of claim 1, wherein the internal and external predetermined vehicular devices associated with the vehicle comprise:
an in-vehicle camera, an on-vehicle camera, and a scanner; and
wherein images and scanned information are uploaded to the CBP server and used as a basis for generating at least one VA CBP interview query.

6. The communication system of claim 1, wherein the CBP server is further communicatively coupled to an external database for verifying at least one response of the responses to the VA CBP interview queries.

7. The communication system of claim 6, wherein the external database comprises at least one of: vehicular registration databases, immigration databases, criminal background check databases, pharmacy location databases, and vehicular location databases.

8. The communication system of claim 1, wherein the in-vehicle processor is further configured to:
automatically detect changes in one or more of: vehicle door position, vehicle window position, vehicle trunk position, and vehicle seat position wherein a change in position is communicated to the CBP server.

9. The communication system of claim 1, wherein the CBP server generates directions for the vehicle in response to a validation status, comprising one of:
a fast pass lane with no further CBP check in response to an all-clear validation;
an electronic follow-up checkpoint in response to in response to an incomplete validation; and
a manual in-person checkpoint managed by CBP personnel for a failed validation.

10. The communication system of claim 1, wherein one or more audio profiles are generated in response to verbal responses to the VA CBP interview queries, and the one or more audio profiles are associated with images of occupants within the vehicle.

11. The communication system of claim 1, wherein automated duty/tax is calculated and charged based on detecting, by the CBP server, that cargo limits of the vehicle are exceeded.

12. The communication system of claim 1, wherein the CBP server is further configured to:
cross-correlate cell phone location history of a cell phone within the vehicle with occupant responses to the VA CBP interview queries pertaining to occupant location history.

13. A method for managing a border crossing, comprising:
automatically establishing a vehicle-to-border communication link with a border checkpoint server in response to the vehicle crossing into a geo-fenced area associated with a customs and border protection (CBP) checkpoint;
granting a CBP server temporary control of predetermined vehicular devices associated with the vehicle to determine occupant and cargo identification information;
validating the identified occupant and cargo based on occupant responses to automated virtual assistant (VA) CBP interview queries, generated by the CBP server, for each identified occupant; and
automatically receiving granted access to a fast pass lane in response to the occupant and cargo identification being validated by the CBP server.

14. The method of claim 13, further comprising, prior to automatically establishing the vehicle-to-border communication link:
registering a user and vehicle to a fast pass CBP application, the registration including granting of access permissions for validating a vehicle, occupants of the vehicle and content of the vehicle; and
automatically establishing a vehicle-to-border communication link within a predetermined geo-fence of a border checkpoint for registered users and vehicles, the link automatically connecting vehicular communication devices and personal communication devices within the vehicle to a CBP checkpoint server.

15. The method of claim 13, wherein the VA CBP interview queries are generated for in-vehicle playout at a communication device within the vehicle while passing through the geo-fenced area.

16. The method of claim 15, wherein the VA CBP interview queries are customized for each occupant based on the occupant and cargo identification information.

17. The method of claim 13, wherein granting the CBP server temporary control of internal and external predetermined vehicular devices associated with the vehicle comprises:
granting the CBP server temporary control of internal and external vehicular cameras, sensors, scanners and communication devices associated with the vehicle to determine occupant and cargo identification information.

18. The method of claim 17, wherein validating further comprises:
generating VA CBP queries for verification of the occupant and cargo identification information; and
comparing responses to the VA CBP queries pertaining to the occupant and cargo identification information to determine a validation status.

19. The method of claim 13, further comprising:
automatically controlling a verified autonomous vehicle including verified occupants and verified vehicle cargo to a fast pass lane.

20. The method of claim 13, further comprising:
generating, by the CBP server, directions for the vehicle in response to a validation status, the direction comprising one of:
a fast pass lane with no further CBP check in response to an all-clear validation;
an electronic follow-up checkpoint in response to in response to an incomplete validation; and
a manual checkpoint managed by in-person CBP personnel for a failed validation.
